(19) United States
(12) Patent Application Publication
(10) Pub. No.: US 2011/0255393 A1
(43) Pub. Date: Oct. 20, 2011

(54) Hydrodynamic bearing assembly, motor provided with hydrodynamic bearing assembly and recording disc driving device equipped with motor

(75) Inventors: Jong Ryeol Oh, Seoul (KR); Ho Kyung Jang, Suwon (KR)

(73) Assignee: SAMSUNG ELECTRO-MECHANICS CO., LTD., Suwon (KR)

(21) Appl. No.: 13/064,330

(22) Filed: Mar. 18, 2011

(30) Foreign Application Priority Data
Apr. 15, 2010 (KR) 10-2010-0034872

(51) Int. Cl. F16C 32/06; G11B 21/02; H02K 7/08

(52) U.S. Cl. 369/215.1; 384/107; 310/90; G9B/21.003

(57) ABSTRACT

There is provided a hydrodynamic bearing assembly that includes: a sleeve with an axial hole into which a shaft is inserted; a radial dynamic pressure unit formed on at least one of an outer diameter of the shaft and an inner diameter of the sleeve; and a sub-radial dynamic pressure unit formed on at least one of the outer diameter of the shaft and the inner diameter of the sleeve in an upper part in an axial direction of the radial dynamic pressure unit, wherein an oil interface formed in an axial hole between the radial dynamic pressure unit and the sub-radial dynamic pressure unit moves up toward the sub-radial dynamic pressure unit as the temperature of a motor rises due to driving of the motor.

### CROSS-REFERENCE TO RELATED APPLICATIONS

This application claims the priority of Korean Patent Application No. 10-2010-0034872 filed on Apr. 15, 2010, in the Korean Intellectual Property Office, the disclosure of which is incorporated herein by reference.

### BACKGROUND OF THE INVENTION

1. Field of the Invention

The present invention relates to a hydrodynamic bearing assembly compensating dynamic pressure for a motor of which a flying height is decreased due to a rise of temperature and in which the rigidity of a bearing is therefore deteriorated, a motor provided with the hydrodynamic bearing assembly, and a recording disc driving device equipped with the motor.

2. Description of the Related Art

In general, a small-sized spindle motor used in a recording disc driving device is a piece of equipment in which a hydrodynamic bearing assembly is used, oil is interposed between a shaft and a sleeve of the hydrodynamic bearing assembly, and the shaft is supported with fluid pressure generated by the oil.

In recent years, with the improvement in performance of the recording disc driving device, requirements such as low current, low NRRO (Non Repeatable Run Out), impact resistance, vibration resistance, etc., have become higher.

In particular, as a spindle motor for a hard disk driver (HDD) is applied to various mobile products such as a netbook, a cellular phone, a PMP, a game machine, etc., research into the miniaturization thereof is in progress.

In general, the hydrodynamic bearing assembly of the motor for the hard disk drive has a design in which an oil interface is formed outside of the sleeve. In the case of such a hydrodynamic bearing assembly, the amount of oil is a very important factor and when the temperature of the motor is increased due to prolonged driving, etc., the viscosity of oil is decreased with thermal expansion of oil.

In the case of the hydrodynamic bearing assembly, the flying height of a rotor case is decreased due to a decrease in oil viscosity and the rigidity of the bearing assembly is deteriorated.

### SUMMARY OF THE INVENTION

An aspect of the present invention provides a hydrodynamic bearing assembly compensating dynamic pressure for a motor of which a flying height is decreased due to a rise of temperature and in which the rigidity of a bearing is deteriorated, a motor provided with the hydrodynamic bearing assembly, and a recording disc driving device equipped with the motor.

According to an aspect of the present invention, there is provided a hydrodynamic bearing assembly that includes: a sleeve with an axial hole into which a shaft is inserted; a radial dynamic pressure unit formed on at least one of an outer diameter of the shaft and an inner diameter of the sleeve; and a sub-radial dynamic pressure unit formed on at least one of the outer diameter of the shaft and the inner diameter of the sleeve in an upper part in an axial direction of the radial dynamic pressure unit, wherein an oil interface formed in an axial hole between the radial dynamic pressure unit and the sub-radial dynamic pressure unit moves up toward the sub-radial dynamic pressure unit as the temperature of a motor rises due to driving of the motor.

Further, the oil interface may move up to the top of a span length of the sub-radial dynamic pressure unit.

In addition, the oil interface may move down toward the radial dynamic pressure unit by flying of the shaft when the motor is started.

The radial dynamic pressure unit may include a herringbone-shaped dynamic pressure groove.

Moreover, the sub-radial dynamic pressure unit may include an in-pump spiral dynamic pressure groove.

The hydrodynamic bearing assembly may further include an oil storage unit recessed on at least one of the outer diameter of the shaft and the inner diameter of the sleeve to store oil, wherein the radial dynamic pressure unit may be formed on the top and bottom in an axial direction of the oil storage unit.

The sub-radial dynamic pressure unit may be positioned axially higher than the radial dynamic pressure unit formed on the top in the axial direction of the oil storage unit.

According to another aspect of the present invention, there is provided a motor that includes: a hydrodynamic bearing assembly; and a rotor rotating in link with a shaft.

According to another aspect of the present invention, there is provided a recording disc driving device that includes: a motor rotating a recording disc; a head transfer unit transferring a head detecting information in the recording disc to the recording disc; and a housing receiving the motor and the head transfer unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor according to an exemplary embodiment of the present invention;

FIG. 2 is a schematic enlarged cross-sectional view of part A of FIG. 1;

FIG. 3 is a schematic diagram showing the position of an oil interface before starting a motor according to an exemplary embodiment of the present invention;

FIG. 4 is a schematic diagram showing the position of an oil interface when a rotor flies from a motor according to an exemplary embodiment of the present invention;

FIG. 5 is a schematic diagram showing the position of an oil interface when the temperature of a motor is increased according to an exemplary embodiment of the present invention; and

FIG. 6 is a schematic cross-sectional view showing a recording disc driving device equipped with a motor according to an exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

In addition, like reference numerals denote parts performing similar functions and actions throughout the drawings.

Hydrodynamic Bearing Assembly and Motor

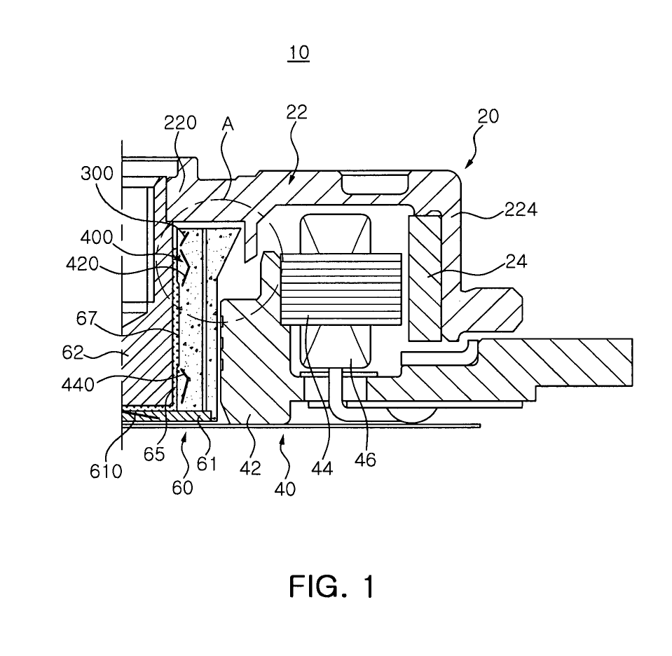

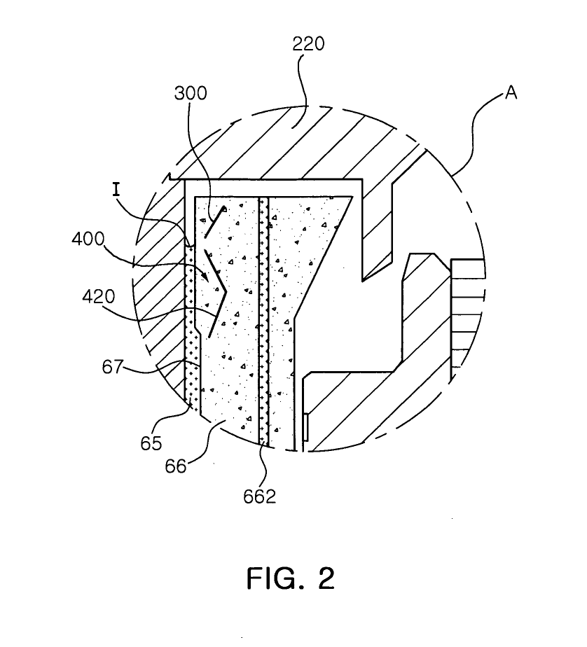

FIG. 1 is a schematic cross-sectional view of a motor according to an exemplary embodiment of the present invention and FIG. 2 is a schematic enlarged cross-sectional view of part A of FIG. 1.

Referring to FIGS. 1 and 2, the motor 10 according to the exemplary embodiment of the present invention may include a hydrodynamic bearing assembly 60, a stator 40; and a rotor 20.

The motor 10 of the exemplary embodiment as a motor for driving recording discs including a magnetic disc such as a hard disc, etc., and an optical disc such as a CD DVD, etc., may generally include a stator 40 and a rotor 20.

The rotor 20 includes a cup-shaped rotor case 22 having a ring clasp type magnet 24 corresponding to a coil 46 of the stator 40 on the outer periphery thereof. The magnet 24 is a permanent magnet in which an N pole and an S pole are alternately magnetized in a circumferential direction to thereby generate magnetic force having a predetermined intensity.

Herein, the rotor case 22 is constituted by a hub base 220 that is pressed on the top of a shaft 62 and a magnet support 224 that extends from the hub base 220 in an outer diameter direction and is bent downward in an axial direction to support the magnet 24 of the rotor 20.

Meanwhile, terms relating to the directions will be defined as follows. In FIG. 1, an axial direction represents a vertical direction on the basis of the shaft 62 and an outer diameter direction or an inner diameter direction represents an outer end direction of the rotor 20 on the basis of the shaft 62 or a center direction of the shaft 62 on the basis of an outer end of the rotor 20.

The stator 40 represents all fixation members other than members that rotate and includes a support 42 to which an outer peripheral surface of the hydrodynamic bearing assembly 60 is inserted and fixed, a core 44 fixed to the support 42, and a coil 46 wound on the core 44.

The rotor 20 is rotated by an electromagnetic interaction between the coil 46 and the magnet 24.

Further, the hydrodynamic bearing assembly 60 may be disposed and fixed to the inside of the support 42 of the stator and may include a sleeve 66, a radial dynamic pressure unit 400, and a sub-radial dynamic pressure unit 300.

The sleeve 66 supports the shaft 62 so that the top of the shaft 62 protrudes upward in the axial direction.

Herein, the shaft 62 is inserted to be spaced from an axial hole 65 of the sleeve 66 by a microgap and oil is filled in the microgap. In addition, the radial dynamic pressure unit 400 formed on at least one of an outer diameter of the shaft 62 and an inner diameter of the sleeve 66 may be formed.

The radial dynamic pressure unit 400 may include a herringbone-shaped groove, and the herringbone-shaped groove generates radial dynamic pressure to smoothly support the rotation of the shaft 62.

Meanwhile, oil is filled in an axial hole 65 between the radial dynamic pressure unit 400 and the sub-radial dynamic pressure unit 300 to form an oil interface I. The oil interface I moves up toward the sub-radial dynamic pressure unit 300 as temperature rises by driving the motor 10.

Herein, in the case of driving temperature, the temperature rise represents a case in which the temperature of the motor 10 rises to a high temperature of 60 to 70° C. and temperature below room temperature may be defined as low temperature.

The sub-radial dynamic pressure unit 300 may include an in-pump spiral dynamic pressure groove, in which when the motor 10 moves up to the top of a span length of the sub-radial dynamic pressure unit 300 at high temperature, the in-pump spiral dynamic pressure groove may prevent the motor 10 from moving up to the top any longer. As a result, oil in the axial hole 65 may be sealed without being dispersed to the outside.

The hydrodynamic bearing assembly 60 of the exemplary embodiment may further include an oil storage unit 67 that is recessed on at least one of the outer diameter of the shaft 62 and the inner diameter of the sleeve 66 to store oil.

The radial dynamic pressure unit 400 may be formed at two points of the top and bottom in an axial direction of the oil storage unit 67. Herein, the radial dynamic pressure unit 400 positioned on the top in the axial direction the oil storage unit 67 will be defined as an upper radial dynamic pressure section 420 and the radial dynamic pressure unit 400 positioned on the bottom in the axial direction of the oil storage unit 67 will be defined as a lower radial dynamic pressure section 440.

The sub-radial dynamic pressure unit 300 may be disposed on the top in an axial direction of the upper radial dynamic pressure section 420.

A support plate 61 supporting the shaft 62 in the axial hole 65 of the sleeve 66 may be provided on the bottom of the sleeve 66. Herein, a thrust generation unit 610 providing thrust dynamic pressure to the shaft 62 may be formed on the bottom of the support plate 61.

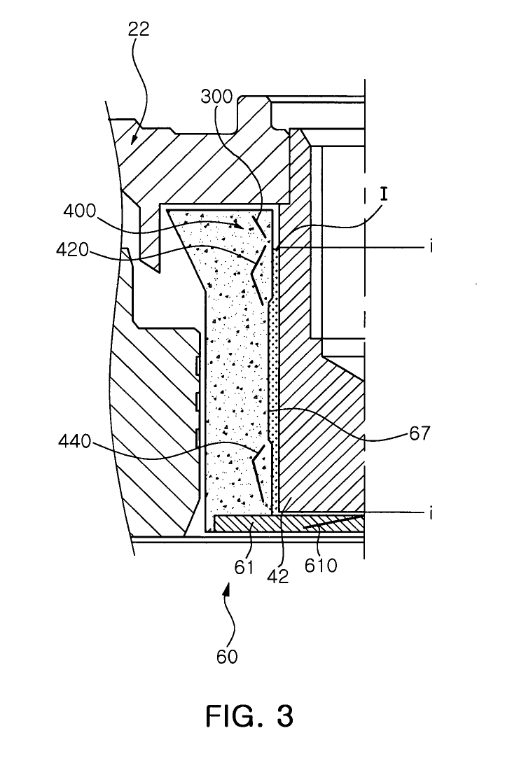

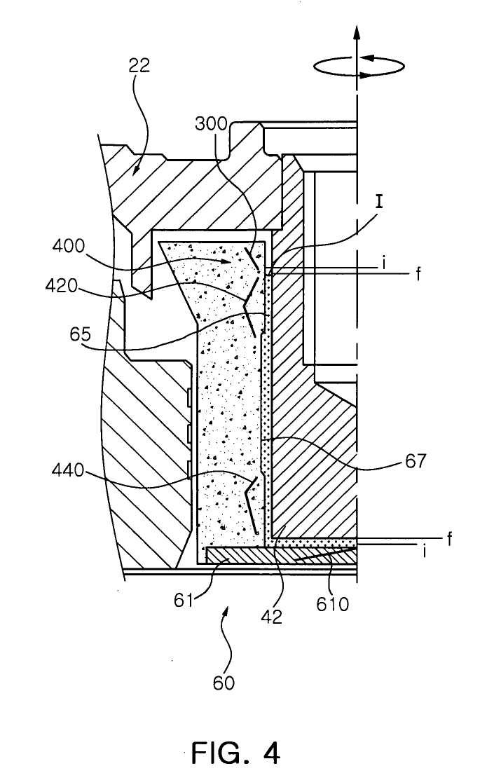

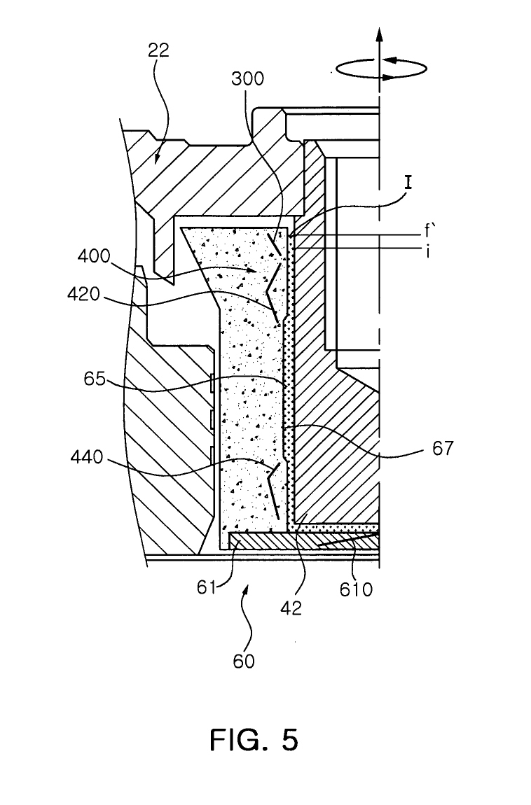

FIG. 3 is a schematic diagram showing the position of an oil interface before starting a motor according to an exemplary embodiment of the present invention, FIG. 4 is a schematic diagram showing the position of an oil interface when a rotor flies from a motor according to an exemplary embodiment of the present invention, and FIG. 5 is a schematic diagram showing the position of an oil interface when the temperature of a motor is increased according to an exemplary embodiment of the present invention.

Referring to FIGS. 3 to 5, a flow process of oil while the motor of the exemplary embodiment of the present invention rotates to raise its temperature in a state where the rotor flies at initial starting is shown.

FIG. 3 shows a state of the motor at initial start-up. An oil interface in the initial state is positioned between the radial dynamic pressure unit 400 and the sub-radial dynamic pressure unit 300 in the axial hole 65.

In addition, FIG. 4 shows a case in which the rotor 20 rotates to fly upwards in the axial direction, causing the shaft 62 that interoperates with the rotor 20 from flying. An initial position of the bottom of the shaft 62 is represented by i and a final position at which the bottom of the shaft 62 moves up is represented by f. When the shaft 62 flies, oil may be introduced between the bottom of the shaft 62 and the support plate 61.

Therefore, the oil interface I located at the initial position i between the radial dynamic pressure unit 400 and the sub-radial dynamic pressure unit 300 moves down as tall as the level of oil introduced between the bottom of the shaft 62 and the support plate 61 (final position f).

Further, referring to FIG. 5, when the temperature of the motor 10 rises to a high level due to prolonged driving of the motor 10, oil is thermally expanded and the oil interface moves up toward the sub-radial dynamic pressure unit 300 (final position f′).

At this time, the sub-radial dynamic pressure unit 300 has the in-pump spiral dynamic pressure grove to prevent oil that moves up to the top in the span length of the sub-radial dynamic pressure unit 300 from moving up any longer.

Recording Disc Driving Device

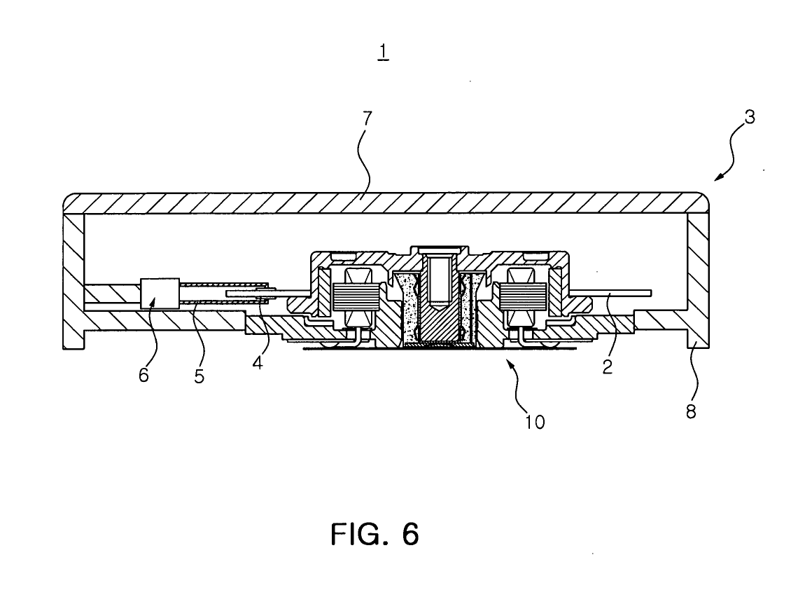

FIG. 6 is a schematic cross-sectional view showing a recording disc driving device equipped with a motor according to an exemplary embodiment of the present invention.

Referring to FIG. 6, the recording disc driving device 1 according to the exemplary embodiment of the present invention, as a hard disc driving device, includes a motor 10, a head transfer unit 6, and a housing 3.

The motor 10 has all the features of the motor of the present invention described above and is equipped with a recording disc 2.

The head transfer unit 6 transfers a head 4 that detects information in the recording disc 2 mounted on the motor 10 onto the surface of the recording disc 2 to be detected. The head 4 is disposed on a support 5 of the head transfer unit 6.

The housing 3 may includes a motor-mounted plate 8 and a top cover 7 covering the top of the motor-mounted plate 8 in order to form inner space receiving the motor 10 and the head transfer unit 6.

As set forth above, according to a hydrodynamic bearing assembly, a motor provided with the hydrodynamic bearing assembly, and a recording disc driving device equipped with the motor of exemplary embodiments of the present invention, when temperature is increased due to prolonged driving, an oil interface moves to an axial-direction top of a sub-radial dynamic pressure device so as to reinforce radial dynamic pressure.

Further, as radical dynamic pressure characteristics are reinforced, NRRO, low current, stability in flying, noise, etc., which are general characteristics of the motor, can be improved.

In addition, since a radial dynamic pressure device is formed in the vicinity of an area where the oil interface is formed, oil sealing power can be strengthened.

While the present invention has been shown and described in connection with the exemplary embodiments, it will be apparent to those skilled in the art that modifications and variations can be made without departing from the spirit and scope of the invention as defined by the appended claims.

What is claimed is:

1. A hydrodynamic bearing assembly, comprising:
a sleeve with an axial hole into which a shaft is inserted;
a radial dynamic pressure unit formed on at least one of an outer diameter of the shaft and an inner diameter of the sleeve; and
a sub-radial dynamic pressure unit formed on at least one of the outer diameter of the shaft and the inner diameter of the sleeve in an upper part in an axial direction of the radial dynamic pressure unit,
wherein an oil interface formed in an axial hole between the radial dynamic pressure unit and the sub-radial dynamic pressure unit moves up toward the sub-radial dynamic pressure unit as the temperature of a motor rises due to driving of the motor.

2. The hydrodynamic bearing assembly of claim 1, wherein the oil interface moves up to the top of a span length of the sub-radial dynamic pressure unit.

3. The hydrodynamic bearing assembly of claim 1, wherein the oil interface moves down toward the radial dynamic pressure unit by flying of the shaft when the motor is started.

4. The hydrodynamic bearing assembly of claim 1, wherein the radial dynamic pressure unit includes a herringbone-shaped dynamic pressure groove.

5. The hydrodynamic bearing assembly of claim 1, wherein the sub-radial dynamic pressure unit includes an in-pump spiral dynamic pressure groove.

6. The hydrodynamic bearing assembly of claim 1, further comprising an oil storage unit recessed on at least one of the outer diameter of the shaft and the inner diameter of the sleeve to store oil,
wherein the radial dynamic pressure unit is formed on the top and bottom in an axial direction of the oil storage unit.

7. The hydrodynamic bearing assembly of claim 6, wherein the sub-radial dynamic pressure unit is positioned axially higher than the radial dynamic pressure unit formed on the top in the axial direction of the oil storage unit.

8. A motor, comprising:
a hydrodynamic bearing assembly of claim 1; and
a rotor rotating in link with a shaft.

9. A recording disc driving device, comprising:
a motor of claim 8 rotating a recording disc;
a head transfer unit transferring a head detecting information in the recording disc to the recording disc; and
a housing receiving the motor and the head transfer unit.
